(19) United States
(12) Patent Application Publication
(10) Pub. No.: US 2011/0225092 A1
(43) Pub. Date: Sep. 15, 2011

(54) Secure Transaction Execution

(75) Inventors: Michael Robert Waithman Lanyon, Kingdom of Bahrain (BH); Richard Ian Fossett, Kingdom of Bahrain (BH)

(73) Assignee: TradeRiver Finance Limited, St. Martin (GB)

(21) Appl. No.: 12/779,016

(22) Filed: May 12, 2010

Related U.S. Application Data
(60) Provisional application No. 61/313,690, filed on Mar. 12, 2010.

(51) Int. Cl. G06Q 20/00; G06Q 30/00; G06Q 90/00; H04L 9/30; H04L 9/32

(52) U.S. Cl. 705/75; 705/44; 705/500

(57) ABSTRACT

A method and system for executing a transaction is described. A payment obligation for a transaction is issued including a transaction value and details of goods and/or services to be provided by a seller following the transaction. An acceptance of the payment obligation is received from the buyer. A determination may be made regarding whether there is sufficient insured credit issued by an insurer for the buyer to cover the transaction value. A funder may be instructed to pay seller funds covering the transaction value following the buyer's acceptance of the payment obligation. A payment to reimburse the funder such that the transaction is executed may be received from the buyer.

### CLAIM OF PRIORITY

This application claims priority to the provisional application entitled, “Secure Transaction Execution” filed Mar. 12, 2010, U.S. Application Ser. No. 61/313,690, the contents of which are incorporated by reference in its entirety.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A letter of credit (LOC) may be used as a source of payment for a transaction so that a seller can be assured of payment. A LOC may be used for international trade transactions of high value but may be used in other forms of trade as well. A seller may negotiate with a buyer the terms and conditions of a transaction including the transaction value, goods or services to be delivered and any timescales for payment and delivery. Other conditions or terms may be included. A bank or other financial institution may issue to the buyer a LOC, which may define the terms and conditions of the transaction. The LOC may be funded by a loan from the bank or deposit from the buyer. The LOC may be sent to the seller's bank so that the goods may be shipped or transferred to the buyer. Upon receipt of documentation verifying that the terms and conditions have been complied with, the buyer's bank transfers payment to the seller's bank so that the seller's account may be credited.

However, the LOC system may be labor intensive, inflexible and slow. Therefore, there is required a system and method that overcomes these problems.

### SUMMARY

According to a first aspect, there is provided a method of executing a transaction comprising the steps of: issuing a payment obligation for a transaction including a transaction value and details of goods and/or services to be provided by a seller following the transaction; receiving from a buyer an acceptance of the payment obligation; determining if there is sufficient insured credit issued by an insurer for the buyer to cover the transaction value; instructing a funder to pay the seller funds covering the transaction value following the buyer's acceptance of the payment obligation; and receiving from the buyer a payment to reimburse the funder such that the transaction is executed.

Each step may be performed using a computer system operating over a network that may be an intranet or the Internet, for example. Preferably, each step may be performed by users acting on behalf of each party to the transaction entering or amending information on computer screens or pages. Advantageously, each entry or amendment may be authenticated and/or certificated. Preferably, this certification includes public key infrastructure (PKI) to ensure non-repudiability of the process. Preferably, this certification includes data and time stamps as well as recordation of screen details.

According to a second aspect, there is provided a system for executing a transaction comprising: a database for storing transactions; a network interface arranged to issue a payment obligation for a transaction including a transaction value and details of goods and/or services to be provided by a seller following the transaction; a processor arranged to store in the database the issued payment obligation and acceptance of the payment obligation from a buyer, determine if there is sufficient insured credit issued by an insurer for the buyer to cover the transaction value, instruct a funder to pay the seller funds covering the transaction value on behalf of the buyer following the buyer's acceptance of the payment obligation, and record a payment received from the buyer to reimburse the funder.

According to a third aspect, there is provided a method of insuring a transaction following a buyer accepting a payment obligation for the transaction including a transaction value and details of goods and/or services to be provided by a seller following the transaction, the method comprising the steps of: determining if there is sufficient insured credit issued by an insurer for a buyer to cover the transaction value; approving the transaction if there is sufficient insured credit; and instructing a funder to pay the seller funds covering the transaction value of the approved transaction on behalf of the buyer.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 illustrates an example secure transaction execution process system in accordance with one or more aspects of the present disclosure;

FIG. 3 illustrates example agreement procedures and interactions in accordance with the present disclosure;

FIG. 4 illustrates an example system for building and executing a transaction in accordance with one or more aspects of the present disclosure;

FIG. 5 is an illustrative flowchart of a method for building and executing a transaction in accordance with at least one aspect of the present disclosure;

FIG. 6 is an illustrative block diagram of a transaction process in accordance with one or more aspects of the present disclosure;

FIG. 7 illustrates an example method of funds transfer in accordance with one or more aspects of the present disclosure;

FIG. 8 illustrates an example of a buyer failing to settle her obligation on a settlement date in accordance with one or more aspects of the present disclosure; and

FIGS. 9-10 are illustrative flowcharts of methods for building and executing a transaction in accordance with at least one aspect of the present disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

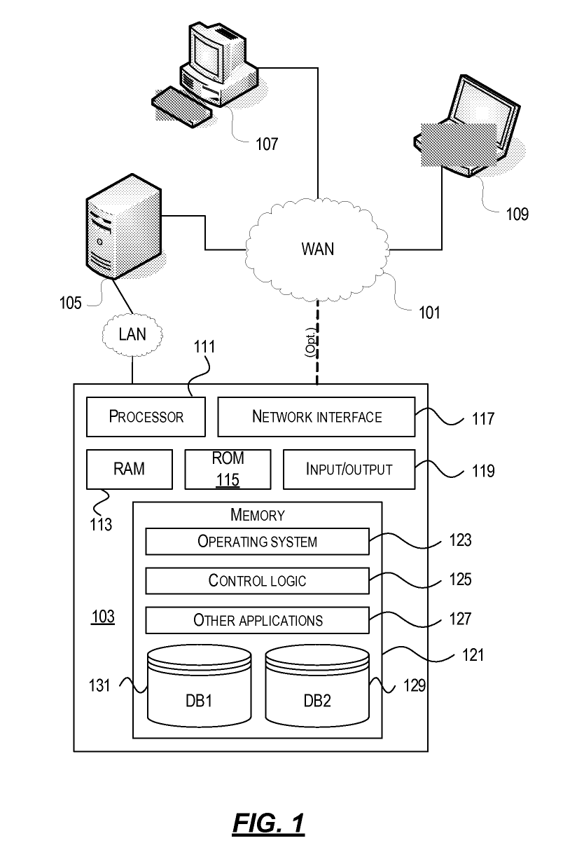

FIG. 1 illustrates one example of a network architecture and data processing device that may be used to implement one or more illustrative aspects of the invention. Various network nodes 103, 105, 107, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects of the invention as described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the rate server 103. Data server 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects of the invention as described herein, and other application software 127 providing secondary, support, and/or other functionality which may or may not be used in conjunction with aspects of the present invention. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the invention, including a first database 129 and a second database 131. In some embodiments, the first database may include the second database (e.g., as a separate table, report, etc.). That is, the information may be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects of the invention may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Aspects of the present disclosure describe a unique, integrated system which provides efficient global trade finance funding and transaction execution for trade between buyers and sellers. A system operating in accordance with the disclosure may use a secure, standardized, transparent, web-based process. Transaction approval and execution may be simple and fast. Buyer credit limits may be set and managed in real time by a credit insurer, transferring credit risk away from a funder to an insurer. A new source of working capital to buyers and sellers may be provided. Buyers may gain pre-approved and secure credit terms up to 180 days. Sellers may gain 100% non-recourse cash settlement immediately, and may finance large transactions. Funders gain attractive short term finance returns within a solid, credit-protected framework. Aspects of the present disclosure link pre-approved, individual corporate credit insurance cover limits to committed funding sources, enabling buyers and sellers to execute trade transactions within those credit limits without paperwork, on-screen in a highly secure and standardized manner.

For the first time, goods or services are separated completely from the obligation to pay for them, and live insurer-applied credit limits are integrated seamlessly with funding facilities. Transactions are executed with reduced or no paperwork. Procedural integrity is superior to that currently available. Dispute and documentation risks are lessened if not eliminated and default risks are quantified, improving risk mitigation for funders, sellers, buyers and insurers—their interests are aligned. Aspects of the present disclosure may be simple, standardized, scalable and cost effective, and may be managed and updated in real time.

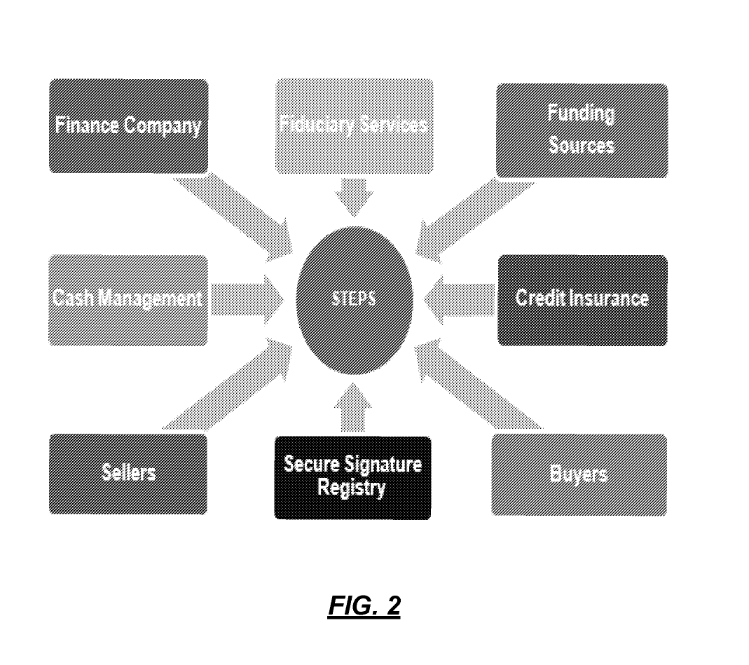

FIG. 2 illustrates a secure transaction execution process system in accordance with one or more aspects of the present disclosure. The system may include a sophisticated, transparent and easy to use transaction execution platform. The system may have all terms, conditions and operating parameters for all parties programmed into the platform. Transactions may be executed entirely on the system. Funding, credit insurance, cash flows, reporting, and all account management may be carried out by the system. All transactions may be monitored, and ultimately approved by a regulated third party fiduciary services provider. All stages may be confirmed by a secure electronic biometric signature system, for example.

The system interlocks any agreements between financer(s), third party fiduciary services provider(s), funder(s), credit insurer(s), and a global cash management provider. The system may provide assured funding and execution for approved transactions.

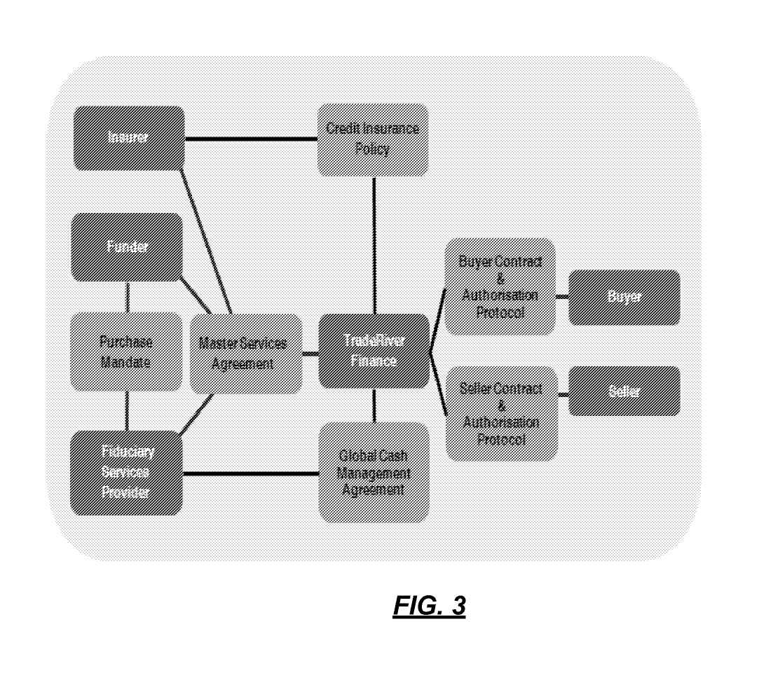

FIG. 3 illustrates agreement procedures and interactions in accordance with the present disclosure. Buyer and seller contracts may be executed once, by the buyer and seller, when they enroll with the system. The system may irrevocably and unconditionally bind the buyers into a payment obligation at a predetermined date. Contracts may include non-repudiation warranties for authentication of transaction signatories.

A credit insurance policy may be a global policy from a credit insurer, which may be A-rated or better, for example. Such a credit insurance policy may provide funder protection, as co-insured or a loss payee, against protracted default, insolvency of the buyer or for any other reason for every transaction.

Fiduciary services agreement may be in place between a financer, a third party fiduciary services provider, and a funder with contracting obligations of the three parties. Such an agreement may identify a funder as a beneficial payee of the credit insurance policy.

A purchase mandate may be in place between a funder, a fiduciary services provider, and a financer detailing all funding parameters and terms and conditions of the funding facility. Such a mandate contracts the fiduciary services provider and the financer to execute only transactions which satisfy the mandate.

A global cash management agreement may be in place between a financer, a fiduciary services provider, and a bank (for example HSBC), detailing procedures for managing cash flows.

A financer may be a regulated company which handles all monies transferred through a tax benign, secure “lock box” account. All funds movement may be controlled by a fiduciary services provider, under the terms of a fiduciary services agreement. A fiduciary services provider independently may ensure the integrity and consistency of the system operation at any or all transaction stages, and may monitor transaction recovery.

Preferably, a prime global trade credit insurer(s) provides global default protection for all transactions. A funder(s) provides transaction funding facilities under individual fiduciary services agreements and purchase mandate terms and conditions. Cash management may be a global, multi-currency cash management facility established with a bank (for example HSBC) to accommodate the needs of system participants, and to provide “lock box” security facilities.

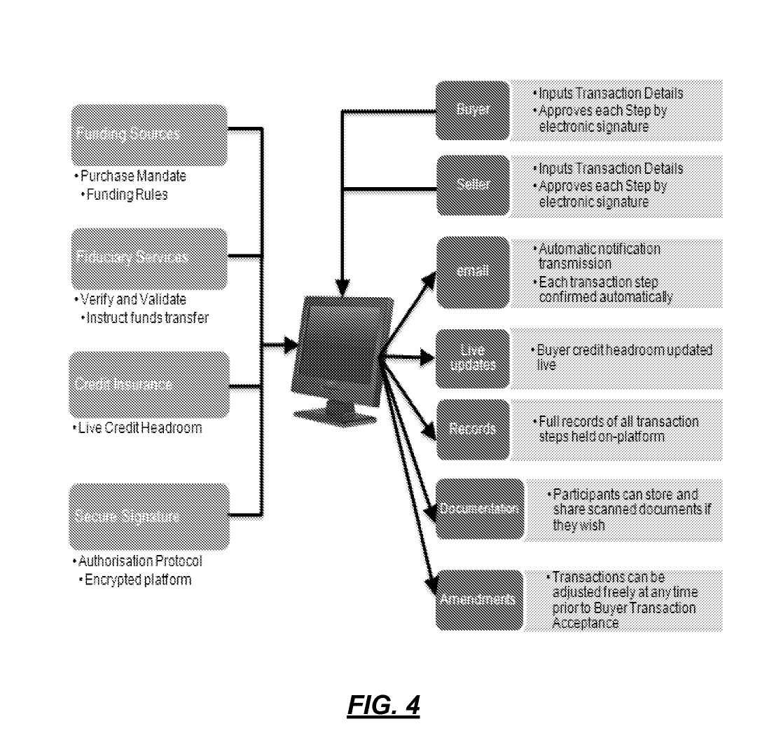

FIG. 4 illustrates the system in accordance with one or more aspects of the present disclosure. The system may be entirely web-based, requiring only standard computer access to operate, for example. The system may be fully scalable, and written in industry-standard languages, such as SQL and Flex® or other suitable languages. Full password, electronic signature and SSL (Secure Socket Layer) encryption may be utilized for example. A duplicate offsite back up facility may preferably be operational 24 hours a day/7 days a week. There may be no ceiling to the number or size of simultaneous transactions. The system may be designed with the aim of minimal downtime and fast recovery rates.

With respect to the process, access to the system may be preferably by password and authenticated e-signature only. A buyer and a seller may be bound by contract to system rules, standards, acceptance of payment obligations and security and signatory warranties. The transaction process may be standardized for all transactions. The system may not allow the entry of any detail which does not comply with the transaction process, fiduciary services agreement or purchase mandate. A third party, independent regulated fiduciary services provider may certify that all stages are completed in accordance with all agreements prior to execution. Each stage of a transaction may be approved by a buyer, seller, fiduciary services provider and/or financer through an authenticated electronic signature or other suitable means. Each signature provides a physical and legally binding record of the process.

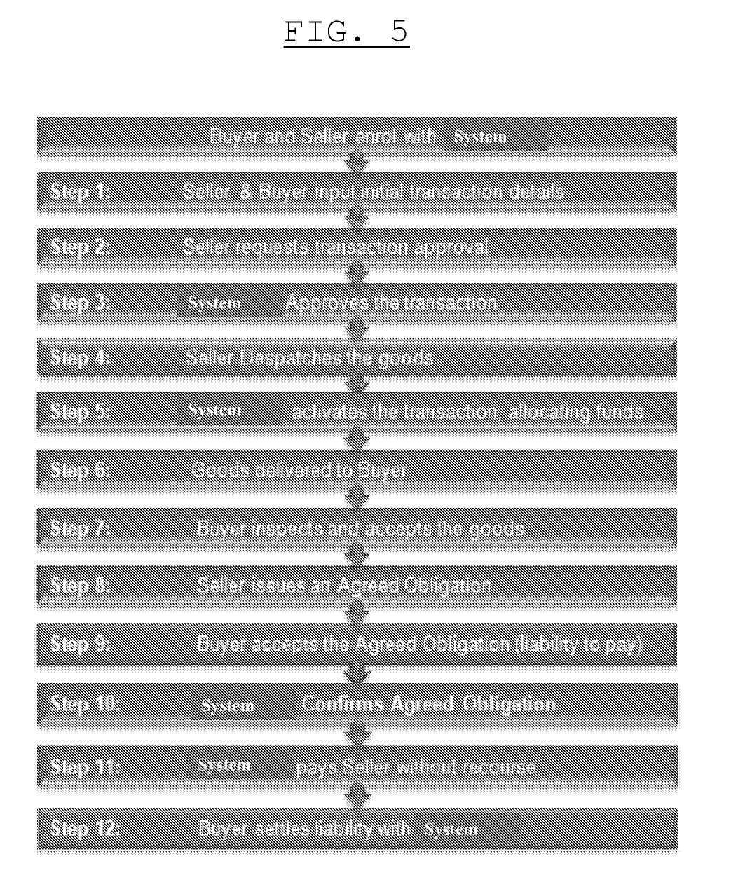

FIG. 5 illustrates transaction stages in accordance with one or more aspects of the present disclosure. A buyer and seller build up the “System Contract” in real (or near real) time and on-screen. The buyer may have a live credit limit from the Insurer, visible to the buyer, the seller, the financial services provider, and the funder. When all terms have been agreed, they submit the transaction to the financer for approval. Approval conditions may be strictly defined by the Insurer (underwriting agreement) and funder (purchase mandate) and may be certified by the third party fiduciary services provider (fiduciary services agreement). Approval may only be given if these conditions are met.

Once goods are dispatched, the transaction may be activated by the financer on the platform, securing the funding pending acceptance by the buyer. Once the goods have been inspected and accepted by the buyer, she electronically may sign her acceptance of the “Payment Obligation” on-screen, triggering 100% payment to the seller immediately and without recourse, and commitment of the buyer to settle in accordance with her credit terms. The buyer may settle with the financer's finance collections account (and thus the funder) on or before a settlement date.

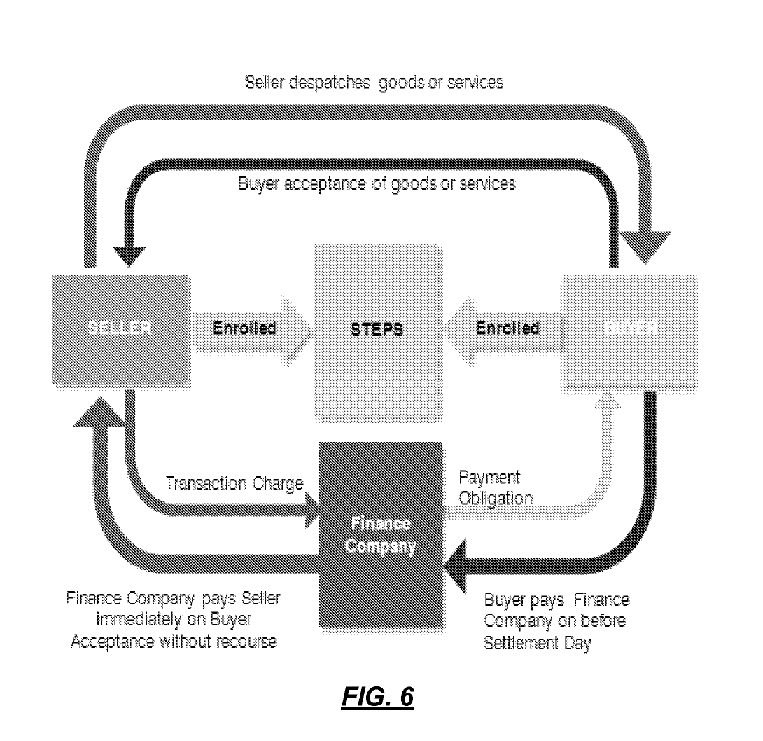

FIG. 6 illustrates an overall flow of a transaction process in accordance with one or more aspects of the present disclosure. A financer may maintain the following general accounts: a general reserve account, i.e., the account which holds Insurer first loss reserves sufficient to cover the insurance policy excess, and a margin account, i.e., the account which holds the financer's transaction charge(s). The financer also may maintain the following accounts for each funder: a facility account, i.e., the account which receives funder drawdown monies, and which pays the seller on transaction acceptance by the buyer, a collections account, i.e., the account to which the buyer pays the transaction amount on or before the settlement date (usually less than 180 day), and a funder reserve account, i.e., the account holding cash reserves to cover the financer's interest liability to the funder in the event of late payment, pending Insurer payment.

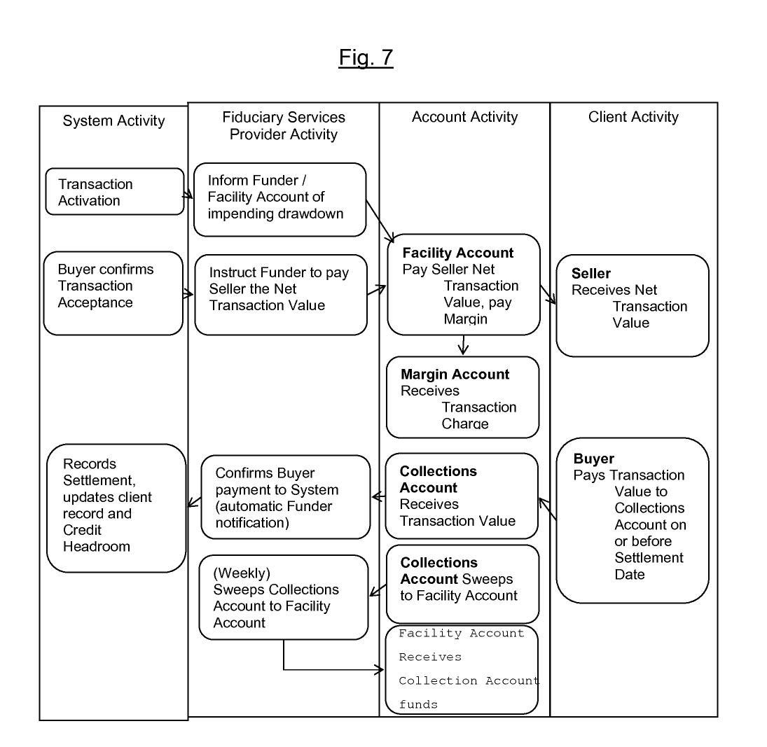

FIG. 7 illustrates the steps relevant to funds transfer in accordance with one or more aspects of the present disclosure. There may be no financial involvement or liability of the financer, its funders or Insurers until the buyer signs to confirm goods acceptance, and hence her legal payment obligation. In this way, the financial transaction may be disinter mediated from the goods transaction and its adherent risks.

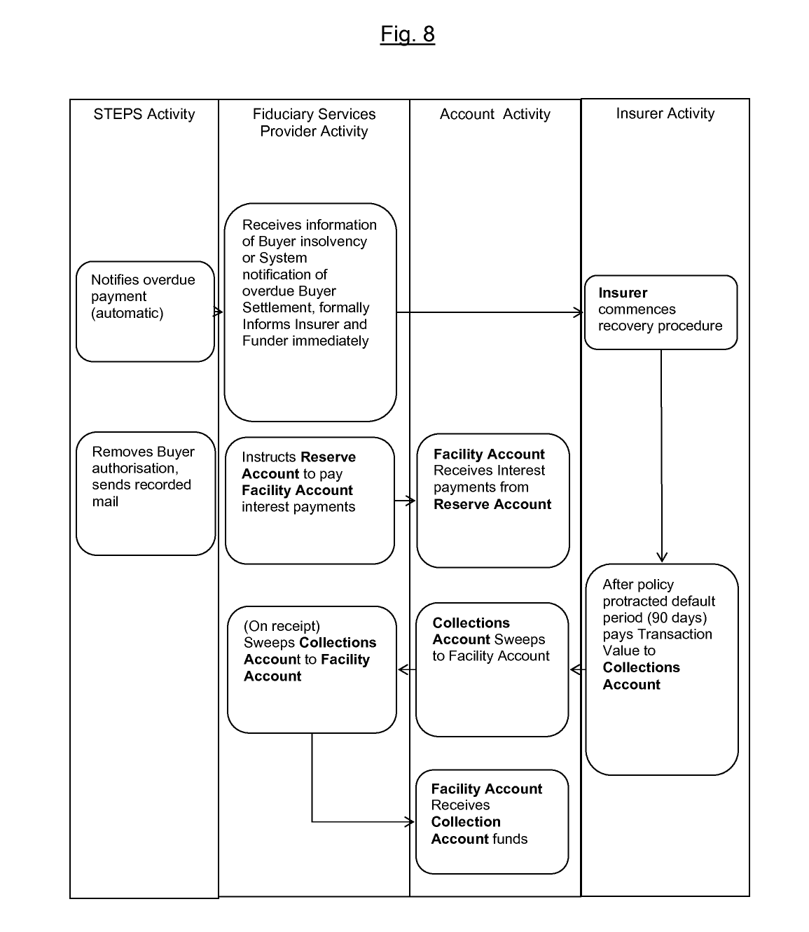

FIG. 8 illustrates the steps relevant to a buyer failing to settle her obligation on a settlement date in accordance with one or more aspects of the present disclosure. In the event the buyer fails to settle her obligation on a settlement date, the obligation recovery procedure may be initiated. The financer, through the fiduciary services provider, may inform the Insurer immediately that a payment is late, or if it has information that a buyer is insolvent. The Insurer may take responsibility immediately after it is informed of late payment or buyer insolvency. The major credit insurance companies, such as Coface, Euler Hermes, and Atradius, are illustrative commercial recovery specialists. The insurance policy terms are straightforward and clear. Insurance liability may be paid within stipulated period after they are informed of late payment. In effect, the financer and its funder have the Insurer as obligor in the event of late payment.

Aspects of the system may be flexible. All details of the transaction may be changed at any stage before the buyer accepts the goods/service—preferably without any paperwork, or any extra cost. Transactions of any size within a buyer credit limit may be executed. Aspects of the system may be transparent. Every aspect of a transaction may be clear to both trading parties and each step of the process may be seen simultaneously by all parties. Aspects of the system include faster transaction processing. A transaction need not be delayed by document checking, re-checking and delivery, funding re-negotiation etc. Aspects of the system include higher security. The system may be behind a secure encryption layer, and all stages may be secured by the biometric signatures of a buyer and a seller authorized signatories with full certificated electronic documentary audit trail. Aspects of the system include lower cost. An all-in transaction charge may be competitive when compared with current letter of credit discounting and factoring solutions. Aspects of the system include common sense. The system may allow the trading counterparties to concentrate on their prime area of expertise—the goods, while the system may take care of the financial arrangements.

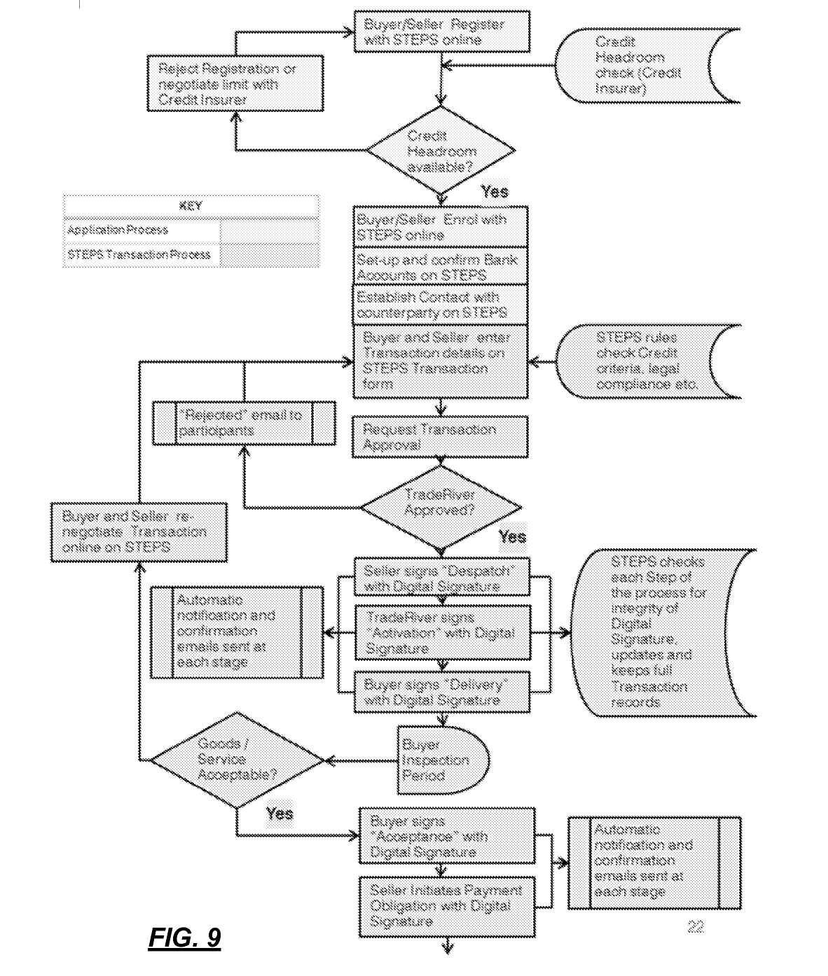

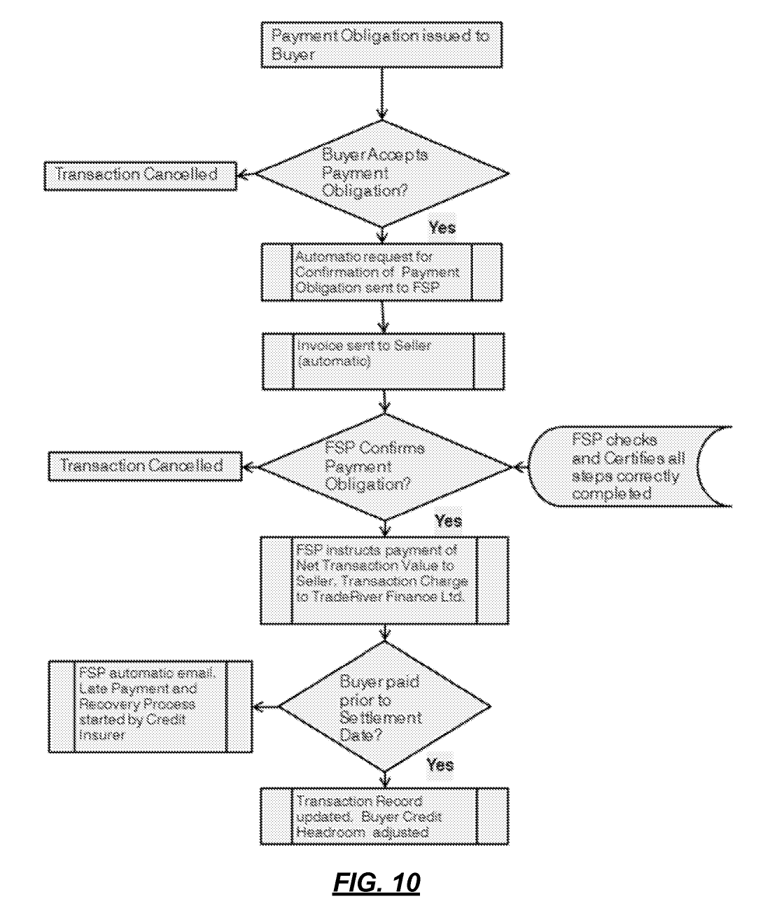

FIGS. 9 and 10 illustrate illustrative process flow diagrams in accordance with one or more aspects of the present disclosure.

Aspects of the present system are designed to help companies fund their financial transactions. These transactions may be for purchases of their normal trade goods or services and purchases of capital items. Companies may join the system either as buyers, sellers, or in some cases both by enrolling with the system. Preferably, buyers and sellers may not be associated companies. Each buyer may be assigned a credit limit within which they must work. This credit limit may be determined in conjunction with a credit insurer, the Insurer. The credit limit may be required to not exceed the Insurer credit limit.

Buyers and sellers may be pre-approved before they may join the system. This approval process involves not only the system but also the Insurer. Both buyers and sellers may be required to be enrolled in the system to use funding to finance a transaction. Once admitted to the system, buyers and sellers may trade with each other using funding from a provider. They may not be committed to using this funding but it is an additional financing option that may be available to them to fund their business transactions/supply chain.

A fiduciary services provider may act as an agent in much of the processing and collection activity to ensure that these processes are carried out within the strict terms of a master underwriting agreement and banking agreements. Each transaction may have checks carried out by the system and by the fiduciary services provider respectively. However the checks carried out as part of a transaction may be limited to verify that both the buyer and seller are enrolled on the system, that the transaction is within the guidelines agreed and within the financial parameters agreed for that buyer.

A buyer may reuse its credit limit many times as long as it is not in default and the total amount in use at any time does not exceed its agreed credit limit. The banking and funding facilities that the system has put in place require representations and warranties from the system. All activities must preferably be compliant with those representations and warranties. All normal daily communications between buyers, sellers, a virtual branch, the system, the Insurer, and the fiduciary services provider are to be through the system wherever possible, or by email, for example. All operations relating to the system are carried out in the system, and scanned copies of all required documentation are held on the system servers 103, and preferably in original form.

Various emails may be sent between parties informing them various steps in each process. A set of email templates is provided from paragraph 0 onwards. Each email template is provided with a reference number referred to in the following description.

The following describes the procedures for the sign up of potential buyers and sellers to the system. A buyer or seller, e.g., the customer, may click a button on a website home page, which may link to a system entry screen. The customer may click “Register,” may enter her initial outline details on a screen, and may click “Register” when complete. An acknowledgement email may be sent to the customer as illustratively shown in Ref: No 1, and the financer may be alerted by email. A check may be performed to ensure that the customer is not an associated company of the system, and an investigation via the Insurer's online credit headroom system may be made to determine whether the customer is a known client of the Insurer, and if so, the customer's indicative credit headroom.

In the event the customer is known to the Insurer and has credit headroom, the Application may be approved, and an email as illustratively shown in Ref: No 2 automatically may be sent to the customer inviting her to enroll on the system. When she clicks on the email link, she may be taken to an enrollment screen. The customer may complete the enrollment details for each authorized signatory on the form, triggering the initial signature registration procedure, until all signatory details are entered. She then may click “All signatories entered, Save and Send”. Each signatory then may be sent an automatic reminder of requirements as illustratively shown in Ref: No 4.

Once all original Know Your Customer (KYC) documentation has been received (copies of original documentation are stored in electronic form on the system server 103, and with the originals preferably retained), an email is automatically sent to the Customer as illustratively shown in Ref: No 5, providing him with a logon and password for the system. When the Customer then logs on to the system he is presented with his Buyer or Seller home screen, as appropriate.

In the event that the customer is not known to the Insurer, or the Insurer has insufficient information about the customer, but the Application is otherwise acceptable at this stage, negotiations on the customer's behalf may be initiated to obtain a customer credit headroom from the Insurer. In the event the financer decides to reject the initial application, the customer may be rejected on the system, and an email as illustratively shown in Ref: No 3 informing the customer of the same may sent automatically. If the Insurer refuses to issue a credit limit for the buyer, or if adverse information is available, the Application may be rejected as illustratively shown in Ref: No 3. If the customer was introduced by an Introducer, an email automatically may be sent to the Introducer informing of the successful application. If at any stage an Application is rejected, a rejection email may be sent as illustratively shown in Ref: No 3. An explanation as to why the application has been declined may not be given.

The following describes the bank account validation process. After the enrollment process, the customer may enter her bank account details on her system “Accounts” screen. Only accounts for which the financer has original documentation, such as bank statements and bank references, may be validated. When the customer has saved her new bank account details, an email as illustratively shown in Ref: No 7 automatically may be sent to her acknowledging receipt, and informing her that validation is pending. When the financer has validated the customer's bank account(s), an email as illustratively shown in Ref: No 8 automatically may be sent to inform her of the same.

The following describes the process for establishment of a contract. A buyer and seller need to establish “Contact” with an intended counterparty prior to being able to carry out a transaction with that counterparty. Buyers may see a list of enrolled sellers under the “Sellers” tab on the system, and sellers may see Buyers under the “Buyers” tab. Buyers and sellers may make contact requests on their “Contact” list. When a contact request is made, an email to the requested party may be sent automatically as illustratively shown in Ref: No 9. The requested party then may accept or refuse the contact, and the buyer or seller may now execute transaction contracts with that contact.

The financer may receive requests from third party brokers to act as an Introducer of buyers and/or sellers, together with any details and names of companies they may wish to introduce. The financer may check whether any of the Introducer's potential customers are introducees of other Introducers. If so, the financer may inform the Introducer that he will not be an Introducer for such customers but welcoming the Introducer as an Introducer for the other customers listed in such a letter. Introducers may register and enroll in exactly the same way as buyers and sellers, and may have an area on the system where they may monitor transactions they have introduced.

The seller may initiate a transaction by selecting “New Transaction” in her “Transaction” tab, and entering the basic transaction details, such as buyer name, purchase order number, invoice number, transaction amount, and goods/service details. The buyer then may enter the required credit days, and the inspection days agreed with the seller. It only may be possible to enter transaction details which satisfy a purchase mandate and buyer credit headroom into the transaction contract.

The seller then may request transaction approval on her transaction screen, which automatically may send an approval request email to the financer. Then one or more checks may be performed ensuring:
The transaction value is within the buyer's credit headroom;
The nature and details of the transaction are within the purchase mandate limits;
Scanned, certified true copies of the applicable purchase orders and declarations of the buyer and seller that they are not associated companies and that the system transaction does not involve deliveries, shipments or performance of services without the necessary license or potentially in violation of any applicable law or regulation, together with scanned copies of any other original documentation prior to transaction execution are held on file;
All transaction contract details entered on a screen are complete;
There is sufficient system liquidity to finance the transaction; and
Both the buyer and seller have accepted said details by electronic signature.

If satisfied with the above checks, the financer may click Transaction Approval, and transaction approval emails may be sent to the buyer and the seller as illustratively shown in Ref: No 15 and Ref: No 16, and the transaction contract status may change accordingly. The seller now may dispatch the goods. Within 24 hours from when the Seller dispatches the goods, she may sign “Dispatch” in the transaction contract, and emails may be sent automatically to the buyer, seller and the financer as illustratively shown in Ref: No 18 and Ref: No 19. Within 24 hours of dispatch for example, transaction activation may be confirmed, and emails may be sent to the buyer, seller and the financer as illustratively shown in Ref: No 20 and Ref: No 21. At this point, the financer through a cash manager may reserve liquidity of the transaction value for this transaction.

Within 24 hours of goods arrival for example, a buyer may sign “Delivery”. Emails may be sent automatically to the buyer and the financer as illustratively shown in Ref: No 22 and Ref: No 22a. On or before the end of the inspection period, the buyer may either Amend or Accept the transaction. If the buyer fails to sign Transaction Acceptance prior to the expiry of the inspection period, or cancels the transaction at any time after delivery, the transaction may lapse, and an email as illustratively shown in Ref: No 30 may be sent to the seller, instructing her to either start a new transaction contract with the buyer, or pursue her own solution with the buyer.

When the transaction is Accepted by the buyer, a confirmation email as illustratively shown in Ref: No 29 may be sent to the buyer, seller and the financer, and asking the seller to issue the agreed invoice. Also, an internal email as illustratively shown in Ref: No 31a from the financer may be sent requesting confirmation that a financial services provider is prepared at this stage to provide final approval of the transaction. When the seller has issued the agreed invoice, an email as illustratively shown in Ref: No 31 may be sent to the buyer, a copy to the seller and the financer, requesting the buyer to accept the agreed invoice.

When the buyer accepts the agreed invoice, an email may be sent to the fiduciary services provider, requesting transaction acceptance as illustratively shown in Ref: No 32, and requesting the transfer of the gate value to the seller. Within eight business hours for example, the fiduciary services provider may inform the financer by email that either it declines to approve the request or accepts it, and if the latter, to process payment by no later than noon on the next business day for example, by authorizing the cash manager electronically to pay the gate value to the seller and the transaction charge to the financer's margin account (in the case of the latter if the buyer has not already paid it) for immediate value in each case.

When the financial services provider has transferred the gate value payment, an email may be sent to the seller to inform her, and the agreed invoice may be updated as illustratively shown in Ref: No 35. When receiving the transaction value from the buyer on, or before a settlement date, the financial services provider may sign the agreed invoice as “Settled.”

The system may calculate the fee due to each Introducer in relation to a system transaction and may request an invoice for the amount from the Introducer as illustratively shown in Ref: No 38. The system may email a payment reminder as illustratively shown in Ref: No 36 to a buyer's authorized signatories at least 10 days for example, prior to a contractual settlement value date or value date. The fiduciary services provider may supply the financer with buyer payment status reports if the fiduciary services provider receives anything other than a positive response from the buyer. The financer may receive the transaction value from the buyer on the contractual settlement value date or value date. The financer may transfer the fee to the Introducer when the buyer pays the transaction value to the financer.

If the buyer, prior to the contractual settlement value date or value date desires to discuss late payment, the buyer may be referred to the fiduciary services provider. If the transaction value has not been paid by a specific time on the contract value settlement date the fiduciary services provider may contact the buyer's authorized signatories to request immediate payment. The fiduciary services provider may inform others, including the Insurer, by email or any other suitable method of any overdue payment and the financer may inform the buyer that its buyer agreement may be terminated and that the buyer must immediately pay the transaction value of all outstanding system transactions by sending an email as illustratively shown in Ref: No 39, and a letter by registered post.

No later than a predefined period e.g. six days after a contractual settlement value date, if the transaction value has still not been received, the fiduciary services provider may commence a formal collection process by sending a notification of overdue account as illustratively shown in Ref: No 39. The financer may send an email to any seller who has an unfinanced system transaction with the buyer whose credit limit has been suspended advising that no further system transaction with the same buyer will be financed by the financer.

The Insurer may initiate and administer the collections process and be solely responsible thereafter for this process. If the buyer is in protracted default, the financer may make a claim under the master underwriting agreement and direct the Insurer to make payment into the financer operations account. The financer may discuss with the fiduciary services provider whether the buyer's Insurer credit limit will be restored. If it is decided not to restore the credit limit, a letter as illustratively shown in Ref: No 40 may be sent by registered post to the buyer. If no payment is received from the buyer, the financer may make a claim under the credit underwriting agreement and may receive payment from the Insurer at a defined period after the notification of overdue account into the financer collection account.

The Appendix contains a technical specification for a preferred embodiment and is provided for illustrative purposes. In this technical specification, the system is called STEPS but the terms “system” and “STEPS” may be used interchangeably. The Appendix also refers to associated figures having similar terminology.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of executing a transaction comprising:
issuing a payment obligation for a transaction including a transaction value and details of goods and/or services to be provided by a seller following the transaction;
receiving from a buyer an acceptance of the payment obligation;
determining if there is sufficient insured credit issued by an insurer for the buyer to cover the transaction value;
instructing a funder to pay the seller funds covering the transaction value following the buyer's acceptance of the payment obligation; and
receiving from the buyer a payment to reimburse the funder such that the transaction is executed.

2. The method of claim 1, further comprising receiving from the buyer a commitment to reimburse the funder after an agreed credit period.

3. The method of claim 1, wherein the funder pays the seller before the payment reimbursing the funder is received.

4. The method of claim 1, further comprising reducing the insured credit for the buyer by the amount of the transaction value.

5. The method of claim 1, wherein the funder pays the seller substantially at the time acceptance of the payment obligation is received from the buyer.

6. The method of claim 1, further comprising deducting a transaction charge from the transaction value such that the seller is paid net of the transaction charge.

7. The method of claim 6, wherein the transaction charge is calculated according to:
TransactionCharge=[(User×CreditPeriod)/360]+TransactionValue×([BuyerInsuranceRate/1000]+[(FirstLoss Reserve×DefaultRate)/10000]+[((FundingCost+BaseRate)×ClaimPaymentDelay×DefaultRate)/3600000]+[(CashManagement+Legal+SPC)/100]+CreditPeriod×[((STEPS+FSP)/(Turnover×360))+((FundingCost+BaseRate+FixedCost)/36000)])×Margin×BuyerLoad.

8. The method of claim 1, further comprising:
identifying the absence of payment from the buyer after an agreed credit period expires.

9. The method of claim 8, further comprising preventing the buyer from accepting any further payment obligations following the identification of the absence of payment.

10. The method of claim 8, further comprising recovering from the insurer the payment.

11. The method of claim 1, wherein the acceptance of the payment obligation further comprises the step of providing a digital signature.

12. The method of claim 1, wherein the digital signature is a non-repudiation digital signature.

13. The method of claim 1, further comprises the step of the buyer and seller negotiating the transaction value and details of goods and/or services to be provided prior to issuing the payment obligation.

14. The method of claim 1, further comprising introducing the buyer and/or seller to participate in the transaction.

15. The method of claim 1, wherein the insured credit and the transaction value are in different currencies and the method further comprises converting one or both into the same currency.

16. The method of claim 1, wherein the step of determining if there is sufficient insured credit further comprises receiving an insured credit amount from a data feed.

17. The method of claim 1, wherein at least one of the steps of: issuing a payment obligation; receiving acceptance from the buyer; instructing a funder; entering transaction details; making amendments to the transaction including amending the transaction value and/or details of goods and/or services; and/or every entry made by a party are certificated.

18. The method of claim 17, wherein the at least one of the steps are certificated using public key infrastructure to determine the identity of a signatory.

19. The method of claim 17, wherein the certificated steps are date and time stamped.

20. A system for executing a transaction comprising:
at least one database configured to store transactions;
at least one network interface configured to issue a payment obligation for a transaction including a transaction value and details of goods and/or services to be provided by a seller following the transaction; and
at least one processor configured to store in the at least one database the issued payment obligation and acceptance of the payment obligation from a buyer, determine if there is sufficient insured credit issued by an insurer for the buyer to cover the transaction value, instruct a funder to pay the seller funds covering the transaction value on behalf of the buyer following the buyer's acceptance of the payment obligation, and record a payment received from the buyer to reimburse the funder.

21. The system of claim 20, wherein the at least one processor is further arranged to receive from the buyer a commitment to reimburse the funder after an agreed credit period.

22. The system of claim 20, further comprising at least one fiduciary server configured to validate the acceptance of the payment obligation.

23. The system of claim 22, wherein the at least one fiduciary server is further configured to validate the payment of the funder to the seller and/or the payment received from the buyer.

24. The system of claim 20, wherein the at least one database is configured to export the stored transactions.

25. A method of insuring a transaction following a buyer accepting a payment obligation for the transaction including a transaction value and details of goods and/or services to be provided by a seller following the transaction, the method comprising:
determining if there is sufficient insured credit issued by an insurer for a buyer to cover the transaction value;
approving the transaction if there is sufficient insured credit; and
instructing a funder to pay the seller funds covering the transaction value of the approved transaction on behalf of the buyer.

26. One or more computer readable media storing computer-readable instructions that, when executed by at least one processor, cause the at least one processor to perform a method of:
issuing a payment obligation for a transaction including a transaction value and details of goods and/or services to be provided by a seller following the transaction;
receiving from a buyer an acceptance of the payment obligation;
determining if there is sufficient insured credit issued by an insurer for the buyer to cover the transaction value;
instructing a funder to pay the seller funds covering the transaction value following the buyer's acceptance of the payment obligation; and
receiving from the buyer a payment to reimburse the funder such that the transaction is executed.
